(19) United States
(12) Patent Application Publication
(10) Pub. No.: US 2025/0200826 A1
(43) Pub. Date: Jun. 19, 2025

(54) VIDEO PROCESSING APPARATUS EXCELLENT IN CONVENIENCE, VIDEO PROCESSING SYSTEM, METHOD OF CONTROLLING VIDEO PROCESSING APPARATUS, AND STORAGE MEDIUM

(71) Applicant: CANON KABUSHIKI KAISHA, Tokyo (JP)

(72) Inventor: HIKARU AOKI, Kanagawa (JP)

(21) Appl. No.: 18/973,418

(22) Filed: Dec. 9, 2024

(30) Foreign Application Priority Data
Dec. 18, 2023 (JP) 2023-212912

(51) Int. Cl. G06T 11/00; G06F 3/01; G06T 7/246; G06T 7/33; G06T 7/73

(52) U.S. Cl. CPC G06T 11/00; G06F 3/013; G06T 7/248; G06T 7/251; G06T 7/337; G06T 7/74; G06T 2207/10016; G06T 2207/30196

(57) ABSTRACT

A video processing apparatus that is used by a first user and processes a video. A real video of a real space visually recognized by the first user is acquired and transmitted to another video processing apparatus used by a second user different from the first user. Motion information concerning motion of the second user is received from the other video processing apparatus. A virtual object of a body part of the second user, which can be displayed in the video, is generated based on the received motion information. A mixed video is generated by mixing the real video and the virtual object. When generating the mixed video, respective positions of the real video and the virtual object are aligned, and the mixed video is generated.

### BACKGROUND OF THE INVENTION

### Field of the Invention

The present invention relates to a video processing apparatus that is excellent in convenience, a video processing system, a method of controlling the video processing apparatus, and a storage medium.

### Description of the Related Art

As a technique of causing a user to perceive a sense different from a reality by performing image processing on an image (captured image) obtained by capturing an image of an object existing in a real space, an extended reality (XR) technique is known. Further, as a representative device for displaying an image to which the XR technique is applied, there is known a head mounted display (HMD) used in a state attached to a head of a person. Further, one of examples use of the XR technique is the XR training. The XR training is performed, for example, by an operator who receives training and a supporter who supports the training for the operator. The operator receives the training in a state wearing the HMD. On the HMD, a device, a tool, and so forth as virtual objects are displayed by computer graphics (CG). The operator can master how to use the device, the tool, and so forth, by operating the virtual objects displayed on the HMD under the support of the trainer. Note that in the XR training, the operator and the supporter are not required to be present in the same real space, i.e. not required to be close to each other in the real space. For example, the operator can be outside a country, and the supporter can be within the country. Japanese Laid-Open Patent Publication (Kokai) No. 2020-195551 discloses a technique in which, by reproducing motion information of a partner, which is stored in advance, on an HMD, a user performs the XR training according to the motion of the partner. Further, Japanese Laid-Open Patent Publication (Kokai) No. 2021-39567 discloses a technique in which virtual objects of fingers of a supporter are generated on the HMD, and the generated virtual objects are superimposed on an operator's hand to thereby teach motion of the fingers of the supporter to the operator.

However, in the technique disclosed in Japanese Laid-Open Patent Publication (Kokai) No. 2020-195551, the training can be performed for the operator only based on the motion information of the partner, which is stored in advance. Further, in the technique disclosed in Japanese Laid-Open Patent Publication (Kokai) No. 2021-39567, the training can be performed only with respect to the motion of the fingers, and hence it is impossible to teach motion of other body part, such as an arm. Therefore, the techniques disclosed in Japanese Laid-Open Patent Publication (Kokai) No. 2020-195551 and Japanese Laid-Open Patent Publication (Kokai) No. 2021-39567 both are not user friendly, i.e. difficult to use, in some points.

### SUMMARY OF THE INVENTION

The present invention provides a video processing apparatus excellent in convenience, which can be used e.g. for training using extended reality (XR), a video processing system, a method of controlling the video processing apparatus, and a storage medium.

In a first aspect of the present invention, there is provided a video processing apparatus that is used by a first user and processes a video, including one or more processors and/or circuitry configured to acquire a real video of a real space visually recognized by the first user, transmit the acquired real video to another video processing apparatus used by a second user different from the first user, receive motion information concerning motion of the second user from the other video processing apparatus, generate a virtual object of a body part of the second user, which can be displayed in the video, based on the received motion information, and generate a mixed video by mixing the real video and the virtual object, and wherein the generating of the mixed video includes generating of the mixed video by aligning respective positions of the real video and the virtual object when generating the mixed video.

In a second aspect of the present invention, there is provided a video processing system including a first video processing apparatus that is used by a first user and processes a video, and a second video processing apparatus that is used by a second user different from the first user and processes a video, wherein the first video processing apparatus includes one or more processors and/or circuitry configured to acquire a real video of a real space visually recognized by the first user, transmit the acquired real video to the second video processing apparatus used by the second user different from the first user, receive motion information concerning motion of the second user from the second video processing apparatus, generate a virtual object of a body part of the second user, which can be displayed in the video, based on the received motion information, and generate a mixed video by mixing the real video and the virtual object, and wherein the generating of the mixed video includes generating of the mixed video by aligning respective positions of the real video and the virtual object, and wherein the second video processing apparatus includes one or more processors and/or circuitry configured to receive the transmitted real video, display the received real video, acquire motion information concerning motion of the second user, and transmit the acquired motion information to the first video processing apparatus.

According to the present invention, it is possible to provide a video processing apparatus excellent in convenience, that can be used e.g. for training using XR.

Further features of the present invention will become apparent from the following description of exemplary embodiments (with reference to the attached drawings).

### BRIEF DESCRIPTION OF THE DRAWINGS

FIG. 1A is a block diagram showing an example of a hardware configuration of a video processing apparatus included in a video processing system according to a first embodiment.

FIG. 1B is a diagram showing an example of a use state of the video processing system shown in FIG. 1A.

FIG. 2 is a block diagram showing an example of a software configuration (functional configuration) of a first video processing apparatus.

FIG. 3 is a diagram showing a table of a relationship between information of a reference position and a method of estimating three-dimensional coordinates corresponding to the reference position.

FIG. 4 is a block diagram showing an example of a software configuration (functional configuration) of a second video processing apparatus.

FIG. 5 is a diagram showing an example of joint position coordinates information stored in a second user tracking information storage unit.

FIG. 6 is a flowchart of a process performed by the first video processing apparatus.

FIG. 7 is a diagram showing an example of a mixed image including a real video and a virtual object.

FIG. 8 is a diagram showing an example of a mixed image including a real video and a virtual object.

FIG. 9 is a flowchart of a process performed by the second video processing apparatus.

FIG. 10 is a block diagram showing an example of a software configuration (functional configuration) of the first video processing apparatus according to a second embodiment.

FIG. 11 is a flowchart of a process performed by the first video processing apparatus.

FIG. 12 is a diagram showing an example of a mixed image including a real video and a virtual object.

### DESCRIPTION OF THE EMBODIMENTS

The present invention will now be described in detail below with reference to the accompanying drawings showing embodiments thereof. The following description of the configurations of the embodiments is given by way of example, and the scope of the present invention is not limited to the described configurations of the embodiments. For example, components of the configuration of the embodiments can be replaced by desired components each of which can exhibit the same function of the corresponding component. Further, a desired component can be added. Further, two or more desired components (features) of the embodiments can be combined.

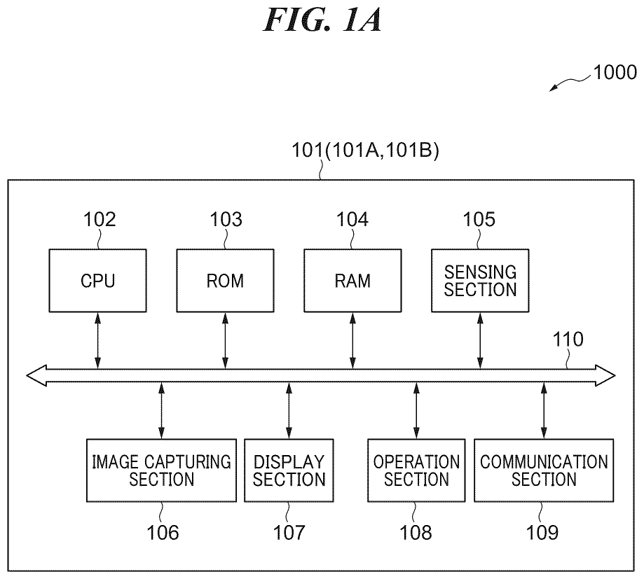

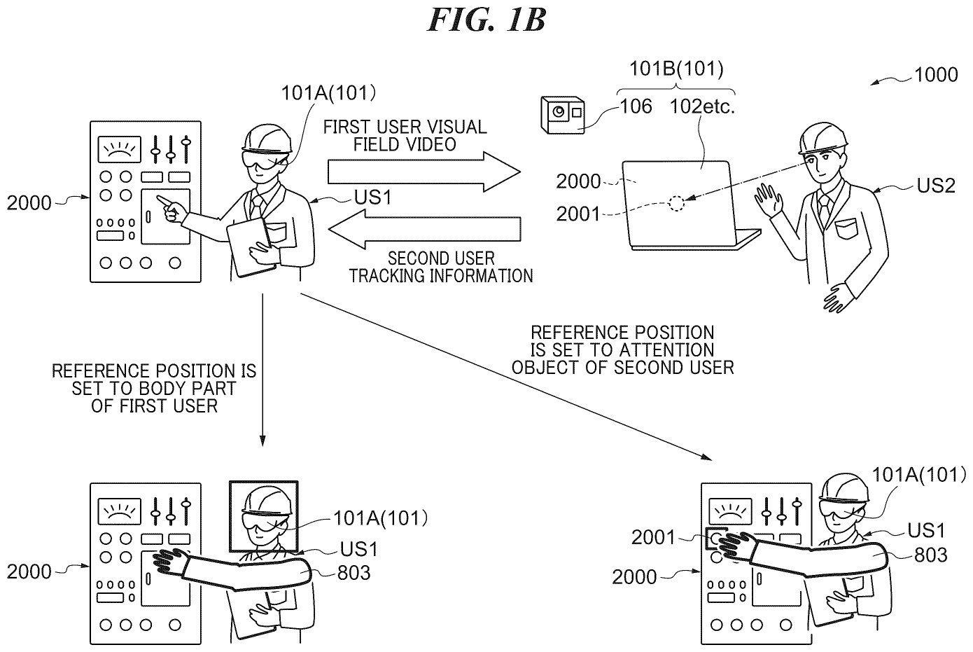

A first embodiment will be described below with reference to FIGS. 1A to 9. FIG. 1A is a block diagram showing an example of a hardware configuration of a video processing apparatus included in a video processing system according to the first embodiment. FIG. 1B is a diagram showing an example of a use state of the video processing system shown in FIG. 1A. As shown in FIG. 1A, the video processing system, denoted by reference numeral 1000, includes image processing apparatuses 101 (101A, 101B) each as the video processing apparatus. As shown in FIG. 1B, the image processing apparatus 101 includes an image processing apparatus 101A as a first video processing apparatus used by a first user US1 and an image processing apparatus 101B as a second video processing apparatus (another video processing apparatus) used by a second user US2. In the present embodiment, the image processing apparatus 101A is a head mounted display (HMD) removably attached to the head of the first user US1. The image processing apparatus 101B is formed by a desktop-type or laptop-type personal computer and a digital camera communicably connected to this personal computer. Note that the image processing apparatus 101A and the image processing apparatus 101B each can be e.g. a personal computer incorporating a web camera.

As shown in FIG. 1A, the image processing apparatus 101 includes a central processing unit (CPU) 102, a read only memory (ROM) 103, a random access memory (RAM) 104, a sensing section 105, an image capturing section 106, a display section (displaying unit) 107, an operation section 108, and a communication section 109, and these components are communicably interconnected via a bus 110. The CPU 102 is an arithmetic processing unit (computer) that comprehensively controls the image processing apparatus 101. The CPU 102 performs a variety of processing operations by executing a variety of programs stored e.g. in the ROM 103. The ROM 103 is a nonvolatile read-only memory device storing the programs and parameters, such as initial data. The programs include an image processing program for causing the CPU 102 to execute a method of controlling the components and means of the video processing apparatus (method of controlling the video processing apparatus), and so forth. The RAM 104 temporarily stores input information, a result of calculation in image processing, and so forth. Further, the RAM 104 also functions as a memory device that provides a work area for the CPU 102. The sensing section 105 is a device, such as a sensor.

The sensing section 105 is capable of performing e.g. motion tracking and eye tracking. With this, it is possible to acquire body motion information and sight line information of a user, and so forth. The image capturing section 106 is an image capturing device that performs image capturing processing. The display section 107 is implemented e.g. by a liquid crystal display. On the display section 107, for example, a captured image obtained by the capturing section 106 and a virtual object, described hereinafter, are displayed. Further, characters, a mark, a figure, an item (such as an icon and contents), and so forth are also displayed on the display section 107. The operation section 108 is an operation unit including a variety of buttons, such as a power button, and operation members including a dial. The communication section 109 transmits and receives data to and from an external apparatus by using wired communication or wireless communication (such as a wireless local area network (LAN) or local 5G). The communication section 109 is a device conforming to a communication standard, such as the Ethernet or IEEE 802.11.

As shown in FIG. 1B, in the present embodiment, the video processing system 1000 is used for on-the-job training (training) in a work site. The first user US1 is a trainee who receives on-the-job training for operating an operation panel 2000 of a machine tool e.g. in a work site of a manufacturing factory. Different from the first user US1, the second user US2 is a trainer. The second user US2 remotely teaches the operation of the operation panel 2000 to the first user US1 and supports the first user US1. Not that the use of the video processing system 1000 is not limited to the use for the on-the-job training in the work site.

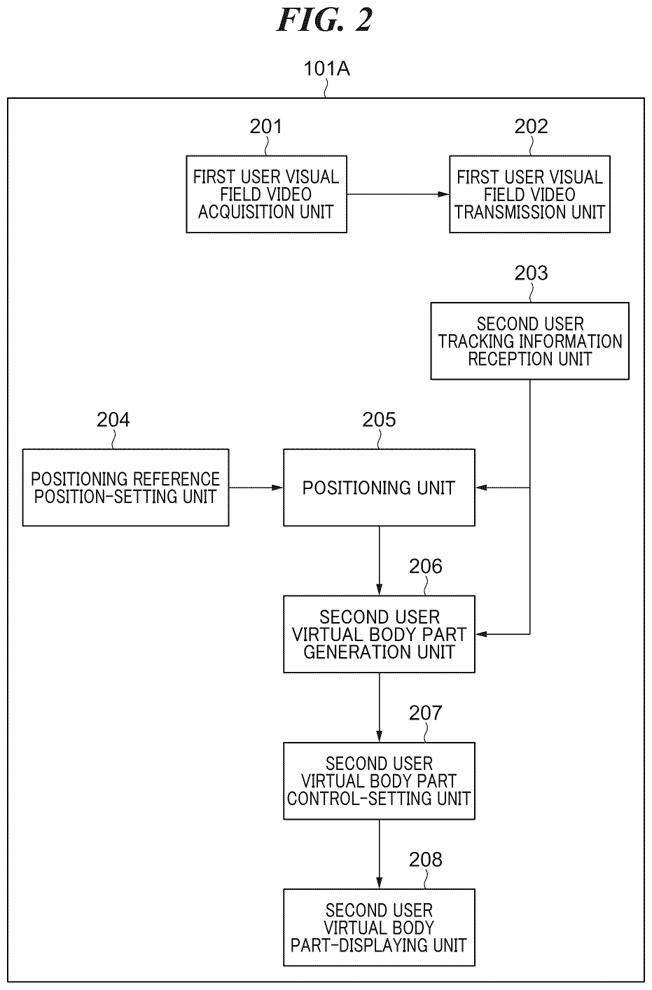

FIG. 2 is a block diagram showing an example of a software configuration (functional configuration) of the first video processing apparatus. As shown in FIG. 2, the image processing apparatus 101A as the first video processing apparatus includes a first user visual field video acquisition unit (video acquisition unit) 201, a first user visual field video transmission unit (video transmission unit) 202, and a second user tracking information reception unit (information reception unit) 203. Further, the image processing apparatus 101A includes a positioning reference position-setting unit (position setting unit) 204, and a positioning unit 205. Further, the image processing apparatus 101A includes a second user virtual body part generation unit (virtual object generation unit) 206, a second user virtual body part control-setting unit (permission setting unit) 207, and a second user virtual body part-displaying unit (video generation unit) 208. Processing operations performed by these software components can be realized by the CPU 102 of the image processing apparatus 101A, which executes programs. Therefore, it can be said that the CPU 102 of the image processing apparatus 101A has these software components.

Note that the CPU 102 is not limited to a CPU that is capable of realizing all processing operations of these software components. For example, the image processing apparatus 101A can have a dedicated processing circuit for realizing one or more processing operations. Note that each software component can exchange information with the other software component by using a desired method. For example, each software component can store acquired information and generated information in the RAM 104 to enable the other software components to acquire these items of information. Thus, in the image processing apparatus 101A, the information can be exchanged between the software components via the RAM 104. Further, each software component can output acquired information and generated information to the other software components without storing these items of information in the RAM 104.

The first user visual field video acquisition unit 201 acquires a real video of a real space, which is captured by the image capturing section 106 and visually recognized by the first user US1, i.e. a visual field video.

The first user visual field video transmission unit 202 transmits the real video acquired by the first user visual field video acquisition unit 201 to the image processing apparatus 101B via the communication section 109.

The second user tracking information reception unit 203 receives motion information concerning motion of the second user US2 (hereinafter referred to as the “second user tracking information”) from the image processing apparatus 101B via the communication section 109. The second user tracking information is not particularly limited, and for example, information concerning the position of a body part of the second user US2, such as an arm and a hand, information concerning the line of sight of the second user US2, and so forth are included in the second user tracking information. Then, the second user tracking information is stored in the RAM 104 of the image processing apparatus 101A.

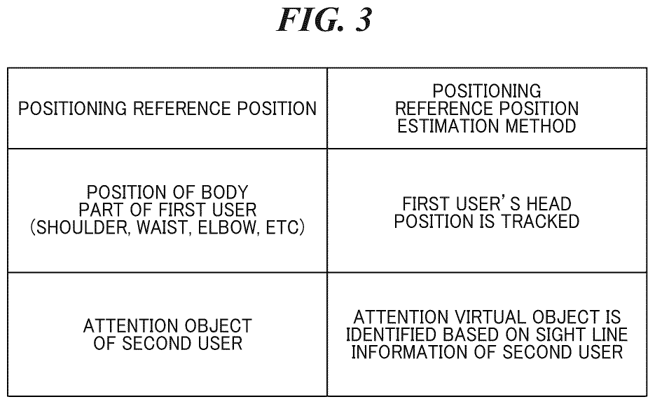

As described hereinafter, a real video acquired by the first user visual field video acquisition unit 201 and a virtual object representing the body part of the second user US2 are mixed to generate a mixed video which can be displayed on the display section 107 of the image processing apparatus 101A. The positioning reference position-setting unit 204 sets a reference position for aligning positions between the real video and the virtual object when generating a mixed video. The reference position can be set to a desired predetermined position, which serves as the common reference position to align the positions of the real video and the virtual object. The three-dimensional coordinates as the reference position are stored in the RAM 104. FIG. 3 is a diagram showing a table of a relationship between a reference position and a method of estimating three-dimensional coordinates corresponding to the reference position. As shown in FIG. 3, as the reference position, it is possible to set, for example, a body part of the first user US1, such as a shoulder, a waist, or an elbow, or an attention object which is positioned on the line of sight of the second user US2 and gazed by the second user US2. In a case where the reference position is set to a body part of the first user US1, the position coordinates of the body part are estimated by the CPU 102 that acquires position coordinates information of the image processing apparatus 101A from the sensing section 105 of the image processing apparatus 101A attached to the head of the first user US1. Further, the position coordinates of the body part can be estimated based on a result of detection performed by a sensor device (not shown) attached to the body of the first user US1. The position coordinates of the attention object are acquired by calculation performed by the CPU 102. Note that the reference position can be changed, e.g. according to a use state of the video processing system 1000, from the body part of the first user US1 to the attention object, and inversely from the attention object to the body part of the first user US1. Further, the attention object is not particularly limited, and for example, e.g. an operation button 2001 (see FIG. 1B) of the operation panel 2000 displayed on the display section 107 of the image processing apparatus 101B can be used. Further, the attention object can be an object existing as a real entity in the real space or a virtual object.

The positioning unit 205 aligns positions between the real video and the virtual object based on the reference position determined by the positioning reference position-setting unit 204. For example, in a case where the reference position is determined to be the head of the first user US1, three-dimensional coordinates of the head position of the first user US1, and three-dimensional coordinates of the head position of the second user US2, which are stored in a second user tracking information storage unit 304, referred to hereinafter, are superimposed (made correspondent to each other). Further, in a case where the reference position is determined to be the attention object, three-dimensional coordinates of the attention object and three-dimensional coordinates of the hand, which are stored in the second user tracking information storage unit 304, are superimposed.

As described above, the second user tracking information reception unit 203 receives the second user tracking information. The second user virtual body part generation unit 206 generates a virtual object of the body part of the second user US2, which can be displayed in a video, based on the second user tracking information. The virtual object is generated by using joint position coordinates information of the second user US2, which is stored in the second user tracking information storage unit 304, referred to hereinafter. Then, the data of the virtual object is stored in the RAM 104. Note that in the present embodiment, the second user virtual body part generation unit 206 generates, out of the body parts of the second user US2, the arm of the second user US2 as a virtual object.

The second user virtual body part control-setting unit 207 sets whether or not to permit an operation on the virtual object of the second user US2 on a mixed video. With this, it is possible to guarantee the security of operation on a virtual object, of which the degree of freedom is appropriately set, i.e. set without excess or deficiency. Note that the operation on the virtual object of the second user US2 in the mixed video can be performed by a variety of components (operation unit), such as a component that recognizes a gesture.

The second user virtual body part-displaying unit 208 displays the virtual object of the second user US2 on the display section 107 of the image processing apparatus 101A. At this time, the second user virtual body part-displaying unit 208 mixes the virtual object and the real video of which the positions are aligned by the positioning unit 205 to generate a mixed video, and displays the generated mixed video. Note that although the second user virtual body part-displaying unit 208 and the positioning unit 205 are provided as separate components in the present embodiment, this is not limitative, but the positioning unit 205 can be included as part of the second user virtual body part-displaying unit 208.

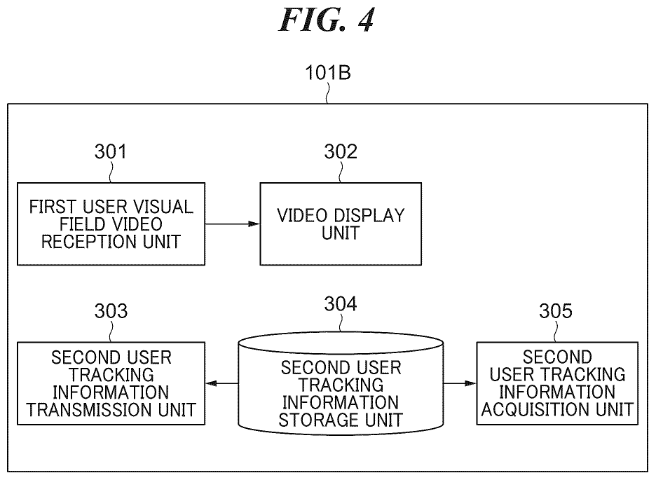

FIG. 4 is a block diagram showing an example of a software configuration (functional configuration) of the second video processing apparatus. As shown in FIG. 4, the image processing apparatus 101B as the second video processing apparatus includes a first user visual field video reception unit (video reception unit) 301 and a video display unit (display unit) 302. Further, the image processing apparatus 101B includes a second user tracking information transmission unit (information transmission unit) 303, the second user tracking information storage unit 304, and a second user tracking information acquisition unit (information acquisition unit) 305. Processing operations performed by these software components can be realized by the CPU 102 of the image processing apparatus 101B, which executes programs. Therefore, it can be said that the CPU 102 of the image processing apparatus 101B has these software components.

The first user visual field video reception unit 301 receives a real video transmitted from the first user visual field video transmission unit 202 via the communication section 109.

The video display unit (display unit) 302 displays the real video received by the first user visual field video reception unit 301 on the display section 107 of the image processing apparatus 101B. Note that the real video preferably includes a virtual object.

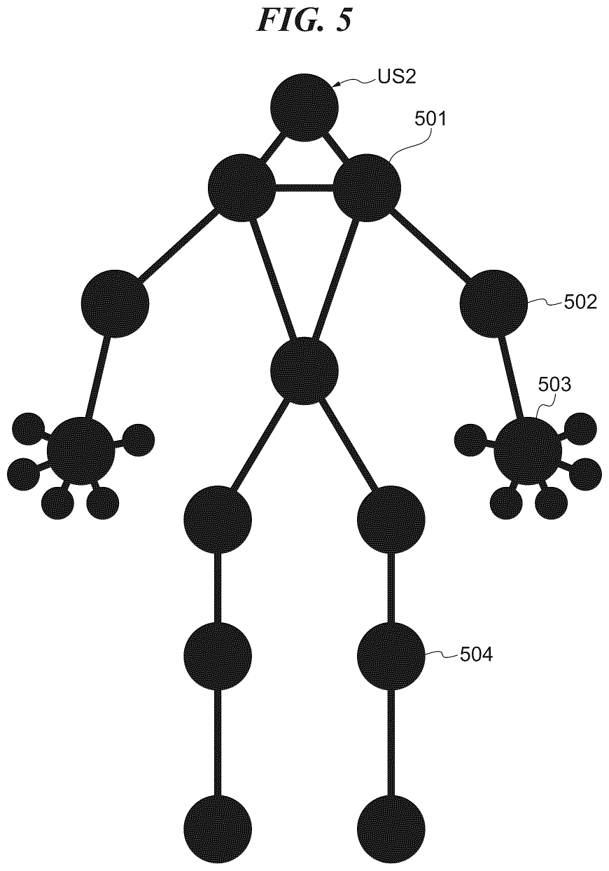

The second user tracking information acquisition unit 305 acquires the second user tracking information. The second user tracking information includes e.g. position coordinates information of joints of the second user US2 and sight line information of the second user US2. Then, the second user tracking information is stored in the second user tracking information storage unit 304. FIG. 5 is a diagram showing an example of the joint position coordinates information stored in the second user tracking information storage unit. As shown in FIG. 5, in the joint position coordinates information, the position coordinates information of the joints of the second user US2, such as a shoulder 501, an elbow 502, a hand 503, and a knee 504, are included. The second user tracking information is obtained by extracting the joint position coordinates information from a video obtained by the image capturing section 106 of the image processing apparatus 101B that captures an image of the second user US2, and analyzing the extracted information. Note that the second user tracking information can be acquired e.g. from a tracking device for motion capture, which is attached to the second user US2. Further, the sight line information of the second user US2 is acquired by the sensing section 105 that measures what area of the display section 107 is gazed by the second user US2.

The second user tracking information transmission unit 303 transmits the second user tracking information stored in the second user tracking information storage unit 304 to the image processing apparatus 101A via the communication section 109.

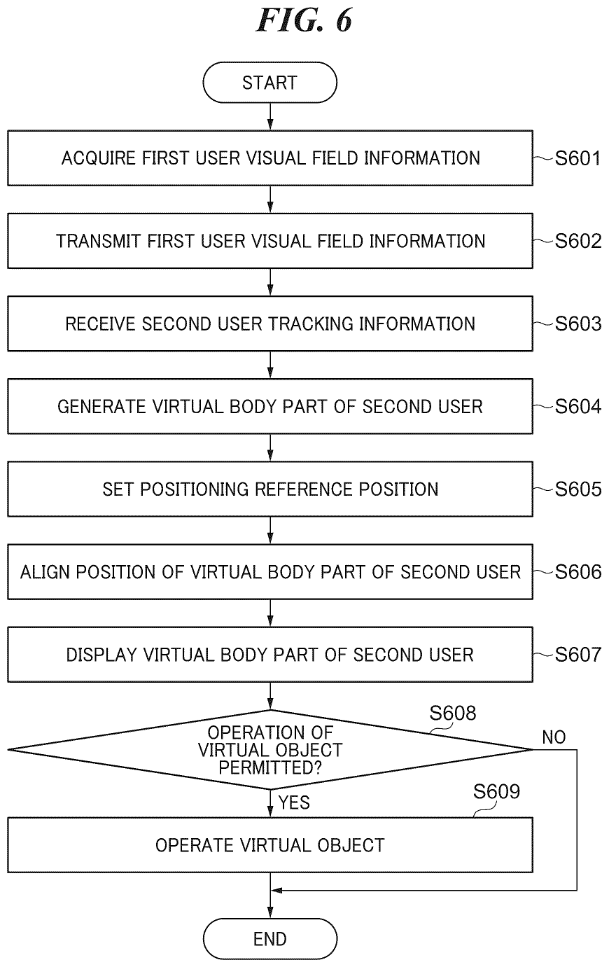

FIG. 6 is a flowchart of a process performed by the first video processing apparatus. The program of the process in FIG. 6 operates when executed by the CPU 102 of the image processing apparatus 101A. Further, let it be assumed, here, that this program operates in a state in which the video processing system 1000 is used for on-the-job training in a work site, by way of example (see FIG. 1B). As shown in FIG. 6, in a step S601, the first user visual field video acquisition unit 201 acquires a real video of a real space, which is acquired by the image capturing section 106 and is visually recognized by the first user US1 who receives training for operating the operation panel 2000, i.e. a visual field video (visual field information). This visual field video is stored in the RAM 104.

In a step S602, the first user visual field video transmission unit 202 transmits the visual field video of the first user US1, which is stored in the RAM 104 in the step S601, to the image processing apparatus 101B via the communication section 109. With this, the visual field video of the first user US1 is displayed on the display section 107 of the image processing apparatus 101B. As shown in the diagram in the upper right part in FIG. 1B, the second user US2 can visually recognize the operation panel 2000 included in the visual field video of the first user US1. Particularly, the second user US2 is looking at the operation button 2001 of the operation panel 2000.

In a step S603, the second user tracking information reception unit 203 receives the second user tracking information from the second user tracking information storage unit 304 of the image processing apparatus 101B via the communication section 109. The second user tracking information is information on a gesture performed as if the second user US2 operates the operation button 2001 on the display section 107 of the image processing apparatus 101B. Then, the second user tracking information is stored in the RAM 104.

In a step S604, the second user virtual body part generation unit 206 generates a virtual object of the body part of the second user US2, based on the second user tracking information stored in the RAM 104 in the step S603. Note that although the body part of the second user US2 is not particularly limited, it is assumed here that the body part is an arm.

In a step S605, the positioning reference position-setting unit 204 sets a reference position for displaying the virtual object generated in the step S604 on the display section 107 of the image processing apparatus 101A. As mentioned hereinabove, the reference position is three-dimensional coordinates for aligning the respective positions of the real video and the virtual object when generating a mixed video. Then, this reference position is stored in the RAM 104.

In a step S606, the positioning unit 205 aligns the respective positions of the real video and the virtual object based on the reference position stored in the RAM 104 in the step S605.

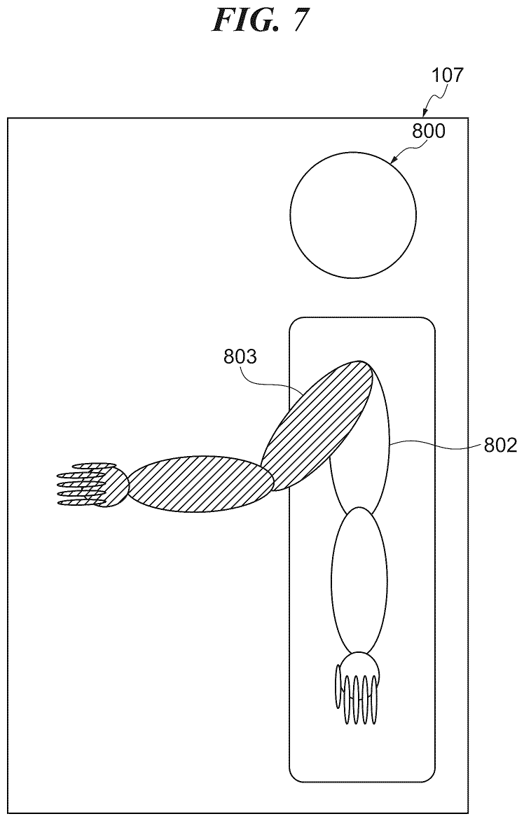

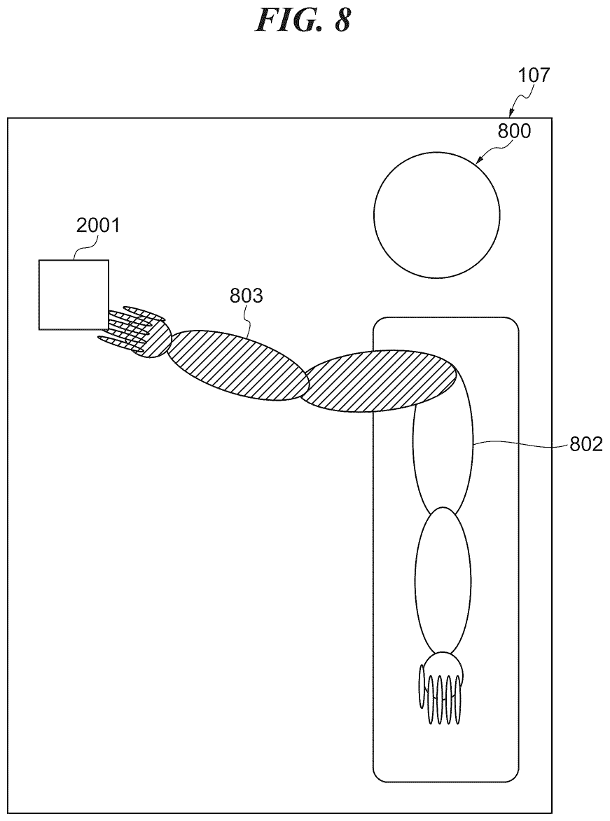

In a step S607, the second user virtual body part-displaying unit 208 generates a mixed image including the real video and the virtual object of which the respective positions are aligned in the step S606, and displays the generated mixed video on the display section 107 of the image processing apparatus 101A. Further, it is assumed that an avatar 800 of the first user US1 is included in the mixed image. This avatar 800 (see FIGS. 7 and 8) is generated e.g. by the second user virtual body part-displaying unit 208 in the present embodiment.

FIGS. 7 and 8 are diagrams each showing an example of a mixed image including a real video and a virtual object. FIG. 7 is a diagram showing the mixed image in a case where the reference position is set to the body part of the first user US1. In the mixed image shown in FIG. 7, position information of a base of an arm 802, i.e. a shoulder (the body part of the first user US1) of the avatar 800, and position information of a base of an arm, i.e. a shoulder of the second user US2, which is included in the second user tracking information, are made corresponding to each other. With this, in the mixed image, a virtual object 803 representing the arm of the second user US2 extends from the shoulder of the avatar 800 of the first user US1. The first user US1 can visually recognize the mixed image shown in FIG. 7. This enables the first user US1 to feel as if the virtual object 803 extending from himself/herself is operating the operation panel 2000, as shown in the diagram in the lower left part in FIG. 1B.

FIG. 8 is a diagram showing a mixed image in a case where the reference position is set to the attention object. In the mixed image shown in FIG. 8, position information of the operation button 2001 of the operation panel 2000 as the attention object and position information of the end of the arm, i.e. the hand of the second user US2, which is included in the second user tracking information, are made correspondent to each other. With this, the mixed image shows a state in which the virtual object 803 as the arm of the second user US2 extends from the shoulder of the avatar 800 of the first user US1 and is operating the operation button 2001. The first user US1 can visually recognize the mixed image shown in FIG. 8. This enables the first user US1 to feel as if the virtual object 803 is operating the operation button 2001, as shown in the diagram in the lower right part in FIG. 1B.

Note that in a case where the body part of the first user US1 is included in the mixed image, the second user virtual body part-displaying unit 208 can temporarily prevent this body part from being displayed. With this, the virtual object 803 is emphasized, and the first user US1 can easily visually recognize the virtual object 803. Thus, the second user virtual body part-displaying unit 208 can have a function of preventing means for temporarily preventing the display of the avatar 800, i.e. can be configured to be capable of performing Diminished Reality (DR). Further, in a case where the body part of the first user US1 is included in the mixed image, the second user virtual body part-displaying unit 208 can eliminate a difference in physiques between the first user US1 and the second user US2. Specifically, the second user virtual body part-displaying unit 208 can eliminate a difference in physiques between the first user US1 and the second user US2, in the body part of the first user US1, and the body part of the second user US2 (virtual object 803), which is being displayed. This makes it possible to make, for example, the length of the arm 802 of the avatar 800 and the length of the virtual object 803, equal to each other, whereby the first user US1 can feel as if the virtual object 803 is operating the operation button 2001 without a feeling of strangeness. Thus, the second user virtual body part-displaying unit 208 can have a function of eliminating means for eliminating a difference in physiques between the first user US1 and the second user US2. In this case, the length of the arm of the first user US1 is acquired in advance.

As shown in FIG. 6, in a step S608, the second user virtual body part control-setting unit 207 determines whether or not to permit the second user US2 to operate the virtual object. If it is determined in the step S608 that the operation of the virtual object is permitted, the process proceeds to a step S609. On the other hand, if it is determined in the step S608 that the operation of the virtual object is not permitted, the present process is terminated.

In the step S609, in a case where the second user US2 has operated the virtual object, the second user virtual body part-displaying unit 208 generates a mixed image on which a result of the operation is reflected, and displays the generated mixed image on the display section 107. Note that information on e.g. vibration generated by the second user US2 operating the virtual object is fed back and can be shared by the first user US1.

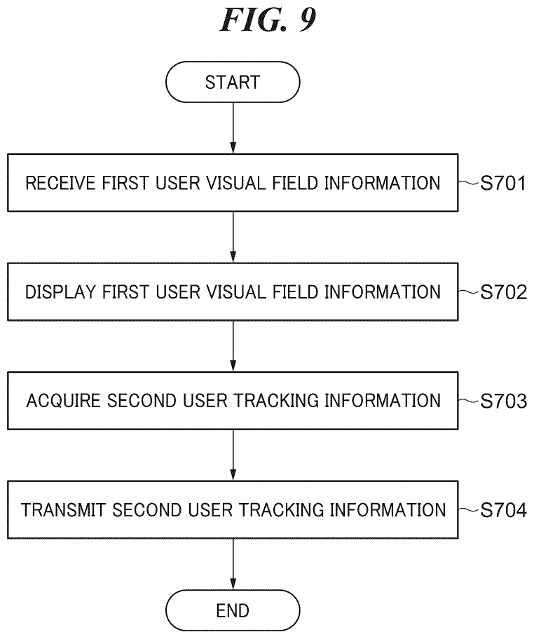

FIG. 9 is a flowchart of a process performed by the second video processing apparatus. The program of the process in FIG. 9 operates when executed by the CPU 102 of the image processing apparatus 101B.

In a step S701, the first user visual field video reception unit 301 receives the visual field video of the first user US1, which has been transmitted in the step S602, via the communication section 109.

In a step S702, the video display unit 302 displays the first user visual field video received in the step S701, on the display section 107.

In a step S703, the second user tracking information acquisition unit 305 acquires the second user tracking information. The second user tracking information is stored in the RAM 104. When the second user tracking information is acquired, the second user US2 moves his/her arm to operate the operation button 2001 included in the visual field video, while visually recognizing the visual field video of the first user US1, which is displayed on the display section 107 of the image processing apparatus 101B.

In a step S704, the second user tracking information transmission unit 303 transmits the second user tracking information stored in the step S703 to the image processing apparatus 101A via the communication section 109, followed by terminating the present process.

In the video processing system 1000 having the above-described configuration, the first user US1 can receive, regardless of a body part gestured by the second user US2, the training for operating the operation panel 2000 from the second user US2 based on the information on the motion of the body part. This enables the first user US1 to accurately operate the operation panel 2000. Thus, the video processing system 1000 is a system which can be used e.g. for training using XR and is excellent in convenience.

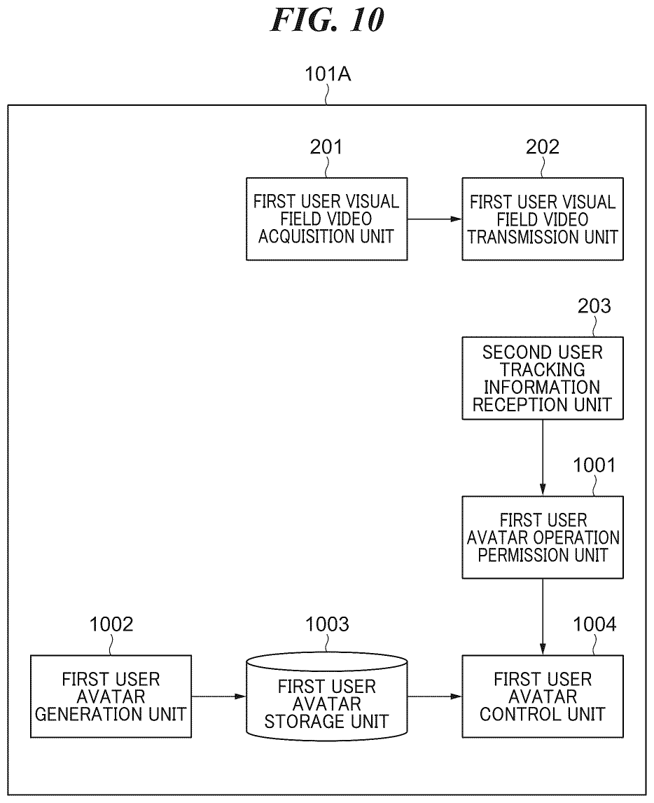

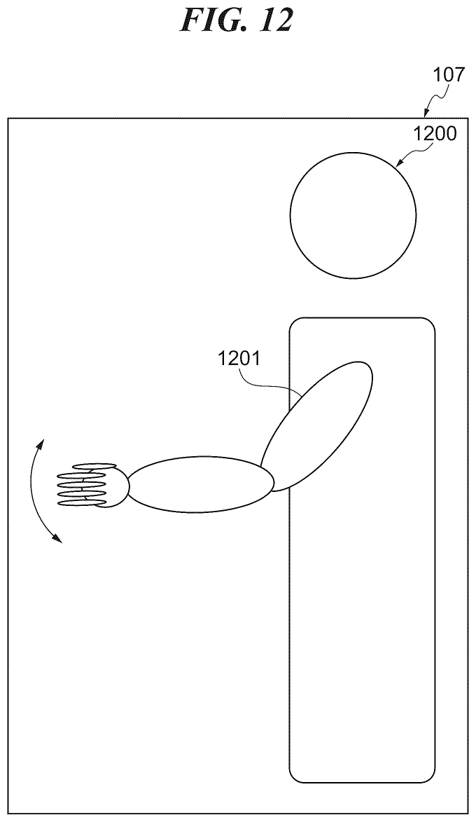

Next, a second embodiment will be described below with reference to FIGS. 10 to 12. The description will be given mainly of different points from the above-described embodiment and description of the same points is omitted. The present embodiment is the same as the first embodiment except that it is possible to perform an operation on the avatar of the first user based on the second user tracking information. FIG. 10 is a block diagram showing an example of a software configuration (functional configuration) of the first video processing apparatus according to the second embodiment. As shown in FIG. 10, the image processing apparatus 101A includes the first user visual field video acquisition unit 201, the first user visual field video transmission unit 202, and the second user tracking information reception unit 203. Further, the image processing apparatus 101A includes a first user avatar operation permission unit 1001, a first user avatar generation unit (avatar generation unit) 1002, a first user avatar storage unit 1003, and a first user avatar control unit (motion control unit) 1004. The first user avatar operation permission unit 1001 sets whether or not to permit the second user US2 to operate an avatar 1200 (see FIG. 12) of the first user US1. This setting information is stored in the RAM 104. The first user avatar generation unit 1002 generates the avatar 1200 which can be operated in the visual field video. The data of the avatar 1200 is stored in the first user avatar storage unit 1003. When an operation on the avatar 1200 is performed based on the second user tracking information received from the image processing apparatus 101B, the first user avatar control unit 1004 controls the motion of the avatar 1200 according to the operation.

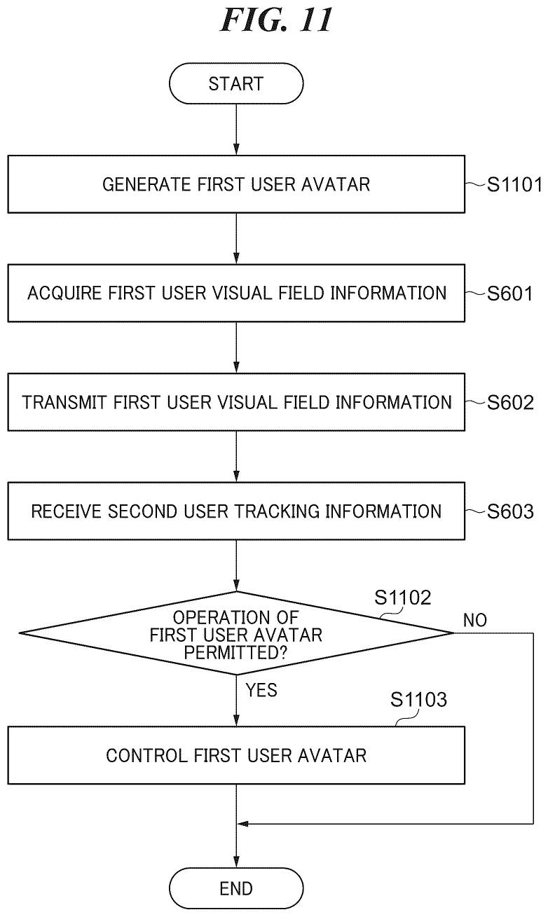

FIG. 11 is a flowchart of a process performed by the first video processing apparatus. As shown in FIG. 11, in a step S1101, the first user avatar generation unit 1002 generates the avatar 1200. The information on the avatar 1200 is stored in the first user avatar storage unit 1003. Further, the avatar 1200 is displayed on the display section 107 of the image processing apparatus 101A. With this, the first user US1 can operate the avatar 1200 on the visual field video. After execution of the step S1101, the process proceeds in a sequence of the steps S601 to 603 (see FIG. 6).

In a step S1102 after execution of the step S603, the first user avatar operation permission unit 1001 determines whether or not to permit the second user US2 to operate the avatar 1200 on the visual field. This determination is performed based on the setting information, stored in the RAM 104, on whether or not to permit the operation of the avatar 1200. If it is determined in the step S1102 that the second user US2 is permitted to operate the avatar 1200, the process proceeds to a step S1103. On the other hand, if it is determined in the step S1102 that the second user US2 is not permitted to operate the avatar 1200, the present process is terminated.

In the step S1103, when an operation on the avatar 1200 based on the second user tracking information received from the image processing apparatus 101B is performed, the first user avatar control unit 1004 controls the motion of the avatar 1200 according to the operation, followed by terminating the present process. FIG. 12 is a diagram showing an example of a mixed image including a real video and a virtual object. Here, the “operation on the avatar 1200 based on the second user tracking information received from the image processing apparatus 101B” will be described. For example, in a case where the second user US2 has pressed the operation button 2001 of the operation panel 2000 by moving his/her arm, motion information of the arm is acquired as the second user tracking information. Then, an arm 1201 of the avatar 1200 presses the operation button 2001 according to this motion of the arm. The mixed image shown in FIG. 12 shows a state in which the arm 1201 of the avatar 1200 is moving based on the second user tracking information (motion information of the arm). With this, the first user US1 can actually operate the operation panel 2000 with accuracy by referring to the mixed image shown in FIG. 12.

The present invention has been described heretofore based on the embodiments thereof. However, the present invention is not limited to the above-described embodiments, but it can be practiced in various forms, without departing from the spirit and scope thereof. The present invention can also be accomplished by supplying a program which realizes one or more functions of the above-described embodiments to a system or apparatus via a storage medium or a network, causing one or more processors of a computer of the system or apparatus to read out and execute the program. Further, the present invention can also be accomplished by a circuit that realizes one or more functions (such as an application specific integrated circuit (ASIC)). Further, although the image processing apparatus 101A is the head mounted display having the components of the CPU 102 to the communication section 109 in the above-described embodiments, this is not limitative. For example, the sensing section 105, the image capturing section 106, and the display section 107 can be omitted from the image processing apparatus 101A, and these components can form the head mounted display communicably connected to the image processing apparatus 101. In this case, the image processing apparatus 101 and the head mounted display can be connected by wired connection or wireless connection.

Further, in the video processing system 1000, the image processing apparatus 101A can be set as a terminal apparatus, and the image processing apparatus 101B can be set as a server communicably connected to a plurality of terminal apparatuses. In the video processing system 1000 in this case, for example, even in a case where the server exists outside Japan, and the terminal apparatus exists within Japan, each file and data can be transmitted from the server to the terminal apparatus, and the terminal apparatus can receive the file and data. Thus, even in the case where the server exists outside Japan, transmission and reception (transmission/reception) of a file and data in this system are collectively performed, i.e. performed without a separate operation performed by a user of the terminal apparatus. Further, since the system functions according to reception of each file and data by the terminal apparatus existing within Japan, it is possible to consider that the transmission/reception are performed within Japan. In this system, for example, even in a case where the server exists outside Japan and the terminal apparatus exists within Japan, the terminal apparatus can perform the main function of this system, and further, can exhibit the effect obtained by this function within Japan. For example, even when the server exists outside Japan, if the terminal apparatus forming this system exists within Japan, it is possible to use this system within Japan by using this terminal apparatus. Further, the use of this system can have influence on the economic benefits e.g. for the patent owner.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212912 filed Dec. 18, 2023, which is hereby incorporated by reference herein in its entirety.

What is claimed is:

1. A video processing apparatus that is used by a first user and processes a video, comprising one or more processors and/or circuitry configured to:
acquire a real video of a real space visually recognized by the first user;
transmit the acquired real video to another video processing apparatus used by a second user different from the first user;
receive motion information concerning motion of the second user from the other video processing apparatus;
generate a virtual object of a body part of the second user, which can be displayed in the video, based on the received motion information; and
generate a mixed video by mixing the real video and the virtual object, and
wherein the generating of the mixed video includes generating of the mixed video by aligning respective positions of the real video and the virtual object when generating the mixed video.

2. The video processing apparatus according to claim 1, wherein the generating of the mixed video includes generating of the mixed video by setting a predetermined position as a common reference position and aligning the respective positions of the real video and the virtual object when generating the mixed video.

3. The video processing apparatus according to claim 2, wherein the one or more processors and/or circuitry is/are further configured to set the reference position.

4. The video processing apparatus according to claim 3, wherein the setting includes setting the reference position to a body part of the first user or an attention object which is positioned on a line of sight of the second user and gazed by the second user.

5. The video processing apparatus according to claim 4, wherein the generating of the mixed image includes making, in a case where the reference position is set to the body part of the first users, position information of the body part of the first user and position information of the body part of the second user, which is included in the motion information, correspondent to each other, as position alignment of the real video and the virtual object.

6. The video processing apparatus according to claim 4, wherein the generating of the mixed image includes making, in a case where the reference position is set to the attention object, position information of the attention object and the position information of the body part of the second user, which is included in the motion information, correspondent to each other, as position alignment of the real video and the virtual object.

7. The video processing apparatus according to claim 3, wherein the setting includes being capable of changing the reference position.

8. The video processing apparatus according to claim 1, wherein the receiving includes receiving of information concerning a position of the body part of the second user or information concerning the line of sight of the second user, as the motion information.

9. The video processing apparatus according to claim 1, wherein the generating of the virtual object includes generating of a virtual object of an arm of the second user.

10. The video processing apparatus according to claim 1, wherein the one or more processors and/or circuitry is/are further configured to:
be capable of performing an operation on the virtual object on the mixed video, and
set whether or not to permit the second user to perform the operation.

11. The video processing apparatus according to claim 1, wherein the one or more processors and/or circuitry is/are further configured to:
generate an avatar of the first user; and
control motion of the avatar of the first user based on the motion information.

12. The video processing apparatus according to claim 1, further comprising a display unit configured to display the mixed video generated by the generating of the mixed video.

13. The video processing apparatus according to claim 1, wherein the one or more processors and/or circuitry is/are further configured to prevent, in a case where a body part of the first user is included in the mixed video to be displayed on the display unit, the body part of the first user from being displayed.

14. The video processing apparatus according to claim 1, wherein the one or more processors and/or circuitry is/are further configured to eliminate, in a case where a body part of the first user is included in the mixed video to be displayed on the display unit, a difference in physiques between the first user and the second user in the body part of the first user and the body part of the second user, which is being displayed as the virtual object.

15. The video processing apparatus according to claim 1, wherein the video processing apparatus is a head mounted display.

16. A video processing system including a first video processing apparatus that is used by a first user and processes a video, and a second video processing apparatus that is used by a second user different from the first user and processes a video,
wherein the first video processing apparatus comprises one or more processors and/or circuitry configured to:
acquire a real video of a real space visually recognized by the first user;
transmit the acquired real video to the second video processing apparatus used by the second user different from the first user;
receive motion information concerning motion of the second user from the second video processing apparatus;
generate a virtual object of a body part of the second user, which can be displayed in the video, based on the received motion information; and
generate a mixed video by mixing the real video and the virtual object, and
wherein the generating of the mixed video includes generating of the mixed video by aligning respective positions of the real video and the virtual object, and
wherein the second video processing apparatus comprises one or more processors and/or circuitry configured to:
receive the transmitted real video;
display the received real video;
acquire motion information concerning motion of the second user; and
transmit the acquired motion information to the first video processing apparatus.

17. A method of controlling a video processing apparatus that is used by a first user and processes a video, comprising:
acquiring a real video of a real space visually recognized by the first user;
transmitting the acquired real video to another video processing apparatus used by a second user different from the first user;
receiving motion information concerning motion of the second user from the other video processing apparatus;
generating a virtual object of a body part of the second user, which can be displayed in the video, based on the received motion information; and
generating a mixed video by mixing the real video and the virtual object, and
wherein the generating of the mixed video includes generating of the mixed video by aligning respective positions of the real video and the virtual object.

18. A non-transitory computer-readable storage medium storing a program for causing a computer to execute a method of controlling a video processing apparatus that is used by a first user and processes a video,
wherein the method comprises:
acquiring a real video of a real space visually recognized by the first user;
transmitting the acquired real video to another video processing apparatus used by a second user different from the first user;
receiving motion information concerning motion of the second user from the other video processing apparatus;
generating a virtual object of a body part of the second user, which can be displayed in the video, based on the received motion information; and
generating a mixed video by mixing the real video and the virtual object, and
wherein the generating of the mixed video includes generating of the mixed video by aligning respective positions of the real video and the virtual object.
